(19) United States
(12) Patent Application Publication
(10) Pub. No.: US 2011/0028379 A1
(43) Pub. Date: Feb. 3, 2011

(54) METHOD FOR A CLEANER USING SILICIC ACID-NATRIUM

(76) Inventor: Nak-Young Baek, Eum-seong-gun (KR)

Correspondence Address: GREER, BURNS & CRAIN, 300 S WACKER DR, 25TH FLOOR, CHICAGO, IL, 60606, US

(21) Appl. No.: 12/747,590

(22) PCT Filed: Sep. 11, 2008
(86) PCT No.: PCT/KR08/05366

§ 371 Date: Sep. 13, 2010

(30) Foreign Application Priority Data
Dec. 12, 2007 (KR) 10-2007-129127

(51) Int. Cl. C11D 3/60

(52) U.S. Cl. 510/402

(57) ABSTRACT

Disclosed is a method for preparing a cleaner containing silicate (64-75% SiO₂) satisfying the standard of silicate contents as defined in the Drinking Water Quality Standards provided by the Ministry of Environment by using sodium silicate (Na₂SiO₃-10H₂O). Sodium silicate is mixed with sodium bicarbonate, dodecylbenzene sulfonate and alkylbenzene sulfonate are added thereto, and then drinking water is further added thereto. Due to the sterilization and cleaning functions of sodium silicate contained in the cleaner, the cleaner is used in cleaning applications, particularly in restaurants and hospitals, or in bathing infants or pet dogs, while not adversely affecting the human body. Additionally, the cleaner has an excellent cleaning effect, and is suitable for cleaning metal surface ions that are in contact with water by inhibiting oxidation of metals. Further, the cleaner is used to neutralize the residual agricultural chemicals on vegetables and to maintain the freshness of vegetables for a long time, in addition to cleaning of general metals.

### TECHNICAL FIELD

The present invention relates to a method for preparing a cleaner by using sodium silicate (Na₂SiO₃-10H₂O) satisfying the standard of silicate contents (64-75% SiO₂) as defined in the Drinking Water Quality Standards provided by the Ministry of Environment, as a main ingredient, by adding a small amount of sodium bicarbonate, dodecylbenzene sulfonate and alkylbenzene sulfonate thereto, and by further adding officially approved drinking water satisfying the Drinking Water Quality Standards thereto.

### BACKGROUND ART

In general, most cleaning agents that have been used to date use some ingredients harmful to the human body, such as surfactants or aromatics, and those causing pollution from wastewater. Thus, when such cleaning agents are in contact with general metals, metal surfaces and ions undergo an undesirable change, resulting in corrosion of metals.

Therefore, there has been a continuous need for an eco-friendly cleaner using no ingredients including surfactants or aromatics that are contained in conventional cleaners, are harmful to the human body and cause environmental pollution.

### DISCLOSURE OF INVENTION

### Technical Problem

The present invention has been made in an effort to solve the above-described problems associated with the related art. Therefore, the present invention provides a method for preparing an eco-friendly cleaner that has excellent antibacterial and deodorizing activities, far infrared ray-emitting property and redox capability, is not harmful to the human body, and causes no environmental pollution, wherein the cleaner includes an eutectic solution containing a silicate compound as a main ingredient and an alkali metal carbonate in water, and dodecylbenzene sulfonate and alkylbenzene sulfonate added thereto.

### Technical Solution

In one aspect of the present invention, there is provided a method for preparing a cleaner using sodium silicate. The method includes: mixing a silicate compound solution containing 100 ppm of sodium silicate dissolved in water with a bicarbonate compound solution containing 100 ppm of sodium bicarbonate dissolved in water in a ratio of 1:1 to provide a sodium solution; mixing dodecylbenzene sulfonate with alkylbenzene sulfonate in a ratio of 2:1 to provide a mixture, and dissolving the mixture into water to a concentration of 100 ppm to provide an additive solution: and mixing the sodium solution with the additive solution in a ratio of 2:1 to provide a mixed solution, and then adding officially approved drinking water to the mixed solution in a predetermined ratio.

### Advantageous Effects

The cleaner containing sodium silicate according to the present invention is not harmful to the human body so that it may be widely used to clean foodstuffs and kitchen utensils and in actual life, particularly to perform laundry cleaning and disinfection. Particularly, the cleaner is capable of preventing iron materials from rusting, and thus it can be widely used in the related applications.

### BEST MODE FOR CARRYING OUT THE INVENTION

The present invention will now be described in detail with reference to non-limiting preferred embodiments thereof.

In one embodiment of the method according to the present invention, a eutectic composition is formed from a silicate compound and an alkali metal carbonate and then triturated to provide a triturated eutectic composition in a liquid phase. The silicate compound used in the method according to the present invention is a silicate compound selected from natural quartzite ores including CaSiO₃, MgSiO₃, Na₂SiO₃, K₂SiO₃ and SiO₂. The alkali metal carbonate used in the method according to the present invention is a carbonate solution selected from potassium carbonate and lithium carbonate.

In a particular embodiment, after a eutectic composition is formed from at least one silicate compound and at least one carbonate, it is cooled and dissolved in water to provide a composition, which, in turn, is mixed and diluted with dodecylbenzene sulfonate, alkylbenzene sulfonate and officially approved drinking water in a pre-determined ratio.

Silicon (Si) has the functions of preventing aging by stimulating cell growth, division and regeneration. Additionally, Si has the functions of promoting in vivo immunity, improving biorhythm-controlling activity, stimulating blood circulation and other circulatory actions, alleviating pains, and enhancing perspiration. Further, presence of a high concentration of SiO₃ in body fluids prevents disorders in the kidney, spleen and liver, and Si-containing ingredients contribute to bone formation and prevention of osteoporosis and arteriosclerosis. In addition to the above, Si has a far infrared ray-emitting effect and shows a high far infrared ray permeability into the body, so that it makes a resonance effect with various organisms forming animal or vegetable bodies. Finally, Si interacts with sulfur (S) and manganese (Mn) to enhance synthesis of amino acids, proteins and fatty acids.

The aforementioned characteristics of silicon allow a silicon-containing silicate (Na₂SiO₃) to be used as a soil improver for agricultural crops. Such soil improver products maximize physical and chemical reactions in the soil in the form of anion-emitting agents, enhance growth of plant roots via suction, and form cuticula layers on cell walls to increase the resistance against harmful insects.

In addition, silicon forms a double silica layer to prevent an attack of pathogens, inhibits generation of ethylene hormones to prevent leaf aging, and emits infrared rays to stimulate cell tissue activation and growth.

Each of the ingredients forming the cleaner, including Si having the aforementioned functions, is represented by any one of the following formulae:

Sodium Silicate Na₂SiO₃—H₂O

Dodecylbenzene Sulfonate

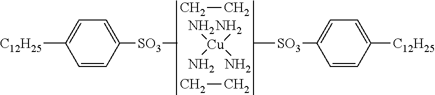

Alkylbenzene Sulfonate C₁₂H₂₅—C₆H₅

Sodium Bicarbonate NaHCO₃

The cleaner composition according to one embodiment of the present invention is preferably formulated as shown in the following Table 1:

TABLE 1

| Ingredients | Amount (%) |
|---|---|
| Sodium silicate | 0.001-8.5 |
| Dodecylbenzene sulfonate | 0.0005-38.5 |
| Alkylbenzene sulfonate | 0.00025-18.75 |
| Sodium bicarbonate | 0.00025-19.25 |
| Officially approved drinking water | 99.998-85 |

### EXAMPLE

Hereinafter, reference will now be made in detail to one embodiment of the method for preparing a cleaner according to the present invention.

First, 2 g of sodium silicate is dissolved into 2,000 cc of water to provide a silicate compound solution containing 100 ppm of a silicate compound. In a separate container, 2 g of sodium bicarbonate is dissolved into 2,000 cc of water to provide a bicarbonate compound solution containing 100 ppm of a bicarbonate compound. Next, the silicate solution is mixed with the bicarbonate solution in a ratio of 1:1 to provide a sodium solution.

Then, 2 g of a mixture containing dodecylbenzene sulfonate and alkylbenzene sulfonate in a ratio of 2:1 is dissolved into 2,000 cc of water to provide an additive solution containing 100 ppm of additives.

After that, 500 cc of the sodium solution is mixed with 250 cc of the additive solution. Then, 1,250 cc of drinking water satisfying the Drinking Water Standards is further added thereto to provide a cleaner.

The cleaner obtained from the above-described method facilitates water purification and activation due to the presence of the sodium solution, and helps water sterilization and disinfection due to the presence of the additive solution. Therefore, the cleaner according to the present invention realizes not only excellent cleaning and disinfection effects but also skin improving effects, while not adversely affecting the human body. Furthermore, since the cleaner according to the present invention is not harmful to the human body and shows high safety, it can be applied to cleaning of fruits, fish, vegetables, kitchen utensils, or the like.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Therefore, the scope of the present invention should not be limited to these exemplary embodiments but should be defined by the appended claims.

1. A method for preparing a cleaner using sodium silicate, which comprises:
mixing a silicate compound solution containing 100 ppm of sodium silicate dissolved in water with a bicarbonate compound solution containing 100 ppm of sodium bicarbonate dissolved in water in a ratio of 1:1 to provide a sodium solution;
mixing dodecylbenzene sulfonate with alkylbenzene sulfonate in a ratio of 2:1 to provide a mixture, and dissolving the mixture into water to a concentration of 100 ppm to provide an additive solution: and
mixing the sodium solution with the additive solution in a ratio of 2:1 to provide a mixed solution, and then adding officially approved drinking water to the mixed solution in a predetermined ratio to provide a cleaner.

2. The method of claim 1, wherein the alkylbenzene sulfonate is represented by the formula of C₁₂H₂₅—C₆H₅ and the dodecylbenzene sulfonate is represented by the following formula:

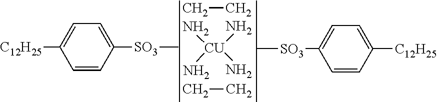

3. The method of claim 1, which further comprises adding a small amount of surfactants and aromatics to the resultant cleaner.
